(19) United States
(12) Patent Application Publication
(10) Pub. No.: US 2024/0217453 A1
(43) Pub. Date: Jul. 4, 2024

(54) DEVICE WITH ADAPTABLE ELEMENTS, SUITABLE FOR FASTENING BOXES, COMPONENTS OR OTHER ACCESSORIES TO THE FRAME OF HEAVY VEHICLES

(71) Applicant: BAWER S.P.A., Matera (MT) (IT)

(72) Inventors: Pasquale LORUSSO, Altamura (BA) (IT); Agostino SARDONE, Altamura (BA) (IT)

(21) Appl. No.: 18/558,416

(22) PCT Filed: Mar. 29, 2022
(86) PCT No.: PCT/IT2022/050070

§ 371 Date: Nov. 1, 2023

(30) Foreign Application Priority Data
May 10, 2021 (IT) 102021000011969

(51) Int. Cl. B60R 11/06; B60R 9/06; B25H 3/02; B25H 5/00

(52) U.S. Cl. CPC B60R 11/06; B60R 9/065; B25H 3/02; B25H 5/00

(57) ABSTRACT

Disclosed is a device with adaptable elements, suitable for fastening accessories boxes, fire extinguisher boxes, or mudguards to the frame of a heavy vehicle, the device having a tubular element equipped with a first section equipped with an annular sequence of prismatic projections equidistant and circularly arranged and a second tubular section, equipped with a row of toothed blocks, the tubular elements being suitable for fastening a metal box or plastic box or plastic plate or U-shaped elements by their simultaneous engagement both inside the coupling elements and inside a toothed flange, the latter being fastened on the front surface of the coupling elements.

The finding object of the present industrial invention patent refers to a device suitable for hooking boxes, components, or other accessories to the frame of heavy vehicles, by plastic tubular elements adaptable to the size of the accessories to be installed.

As known, vehicles of N, O, S, T and G categories such as trailers, agricultural machines, industrial vehicles, and special vehicles, are often equipped with one or more accessories boxes or components or other accessories, made of metal or plastic material, engageable to the vehicle frame by using brackets of various shape and size, with the aid of bolted-type connections.

Brackets commonly used for fastening the accompanying accessories to the frames of heavy vehicles are made in accordance with several geometries, to be suitable for accommodating the size of boxes or components or other accessories to be installed.

Various typologies by which known brackets are provided are conditioned not only by the geometrical nature of the type of box or components or other accessories to be installed, but also by the load to be sustained, such as for example in case of metal boxes intended to accommodate heavier tools or accessories.

Currently adopted technical solution for fixing boxes or components or other accessories on vehicles is to use at least four anchoring points for the supporting brackets, which generally takes place by bolted connections and with not always short installation time, as it is necessary to pierce the walls of accessories boxes or components or other accessories in the intended anchoring point in order to fasten the ends of the supporting brackets themselves.

Installing boxes or components or other accessories by the known systems does not allow a possible interchangeability of these latter with others of different type or size, making therefore installations of said boxes or components or other accessories performed on a vehicle frame section definitive.

An anchoring system for accessories boxes of heavy vehicles, referred to as quick-coupling, is known, which feature is to seriously reduce the installation time because of a smaller number of needed components for fixing box, as well as using fastening systems with quick-type elastic couplings, which offer the advantage of replacing at least part of the bolted connections typically used in traditional systems.

An object of the present finding is to provide a fastening device for boxes or components or other accessories which can be applied regardless of the installation quota relative to the outer surface of the vehicle, said object being achieved by using tubular elements which are equipped with a neat sequence of prismatic relief subdivisions and toothed blocks suitable for engaging inside a coupling element, with the possibility to remove a portion of the tubular element, in accordance with the installation quota of the box or components or other accessories to be fastened relative to the vehicle.

A further object is to provide a support device for boxes or other component or other accompanying accessories of heavy vehicles, of quick-coupling type and easy mounting, through a tubular element that, when inserted inside the coupling element, achieves the engaging condition by some toothed blocks it is equipped with, suitable for being elastically constrained in prepared cavities of the coupling element, quickly reaching the engaging condition and without the aid of any other type of traditional fastening means.

An object of the present finding is still to provide a very light fastening device for boxes or other component or accessory which simultaneously has the property to sustain the same loads as the conventional heavier metal brackets, said object being achieved through the adoption of a plastic material tubular element equipped with particular internal structural ribs, adapted to increase the performance ability thereof in terms of mechanical strain strength.

A further object of the finding is to allow a quick replacement of a box or components or other accessories with others of different type or geometry, unfastening the tubular element from its engaging condition inside the coupling element, through a quite easy manoeuvre and by using common equipment suitable for elastically disengaging toothed shapes of the tubular element fastened inside the coupling elements.

A further advantage of the finding is to have replaced the metal elements, commonly used for hooking boxes or components or other accessories to the vehicle frame, with elements made of recyclable and eco-sustainable materials.

From a production point of view, an advantageous aspect of the finding is further due to the fact of being able to provide all its components with injection moulding techniques of plastic materials, thus dispensing with all the typical processing steps used for making metal elements, as in case of traditional brackets, by the steps of metal sheet cutting, folding, piercing and finishing, which assist in increasing production cycle time and costs.

At last, a further object of the present invention is to provide a hooking bracket which can be used whenever it is necessary to engage to the frame of trucks, articulated lorries or other types of heavy vehicles any type of accessory or structural element such as, for example, indicatively and not exhaustively: fire extinguisher holders, license plate holders, light holders and mudguards.

These and other objects are achieved by the device with adaptable elements suitable for fastening accessories boxes of heavy vehicles of the present industrial invention patent, described in a preferred embodiment, not limiting, further developments in the scope of the patent, with the aid of the accompanying drawings illustrating the following figures:

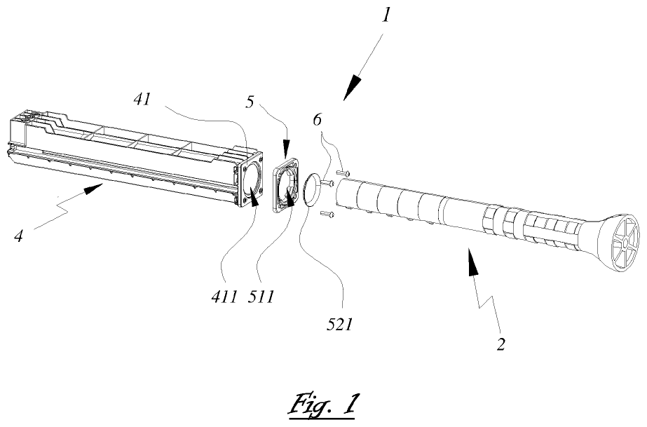

FIG. 1, an isometric view of the device;

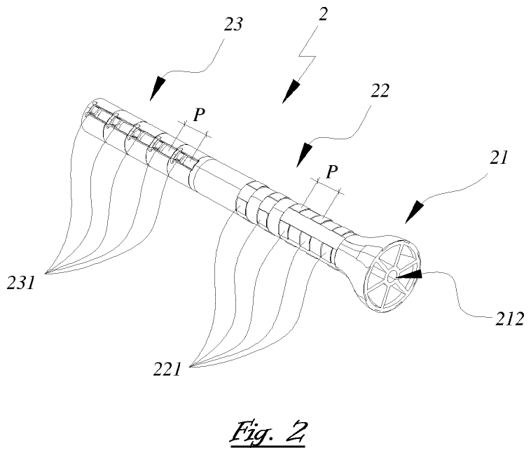

FIG. 2, an isometric view of the tubular element;

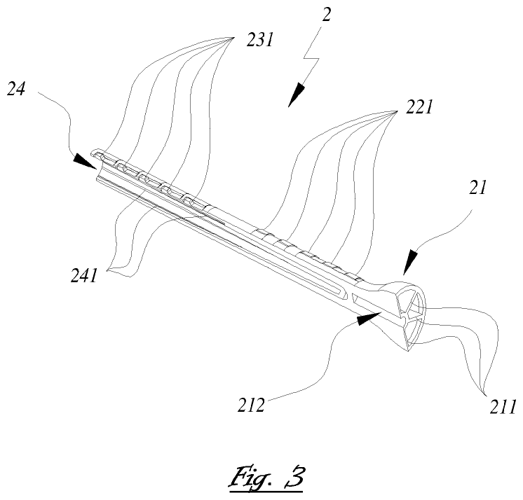

FIG. 3, a sectional isometric view of the tubular element;

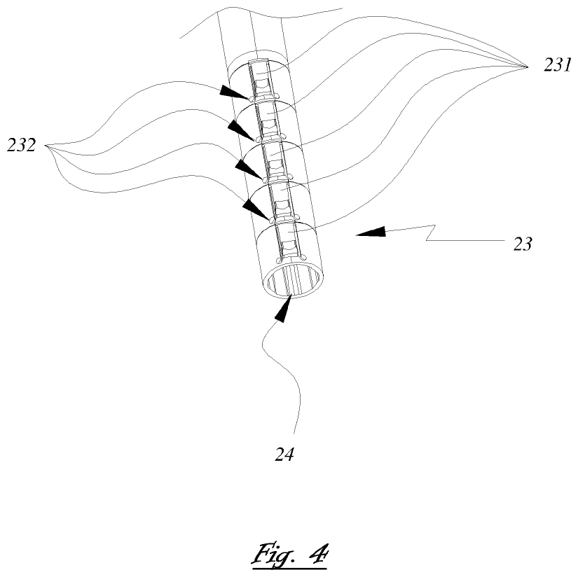

FIG. 4, a detail view of the free end of the tubular element;

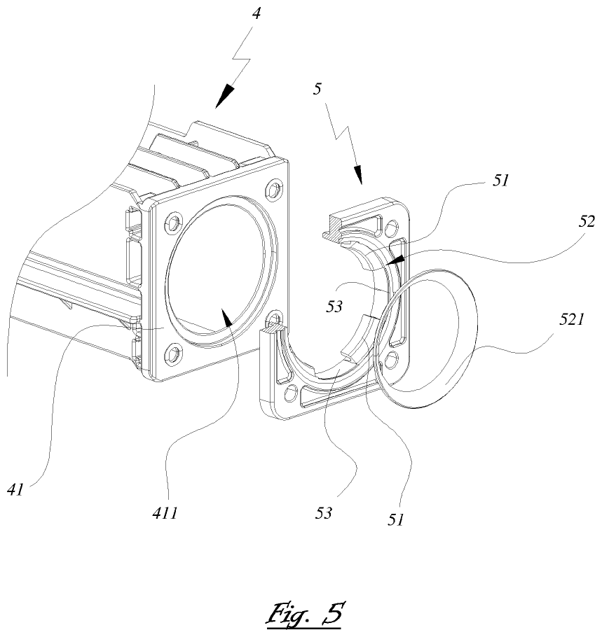

FIG. 5, a partial section exploded isometric view of the toothed flange and the annular lip element;

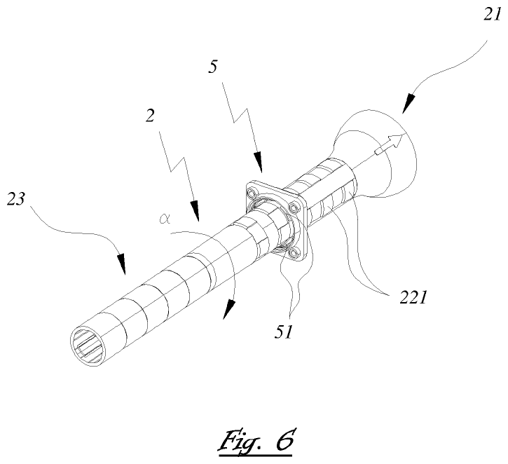

FIG. 6, an isometric view illustrating the disinsertion manoeuvre of the tubular element inside the toothed flange;

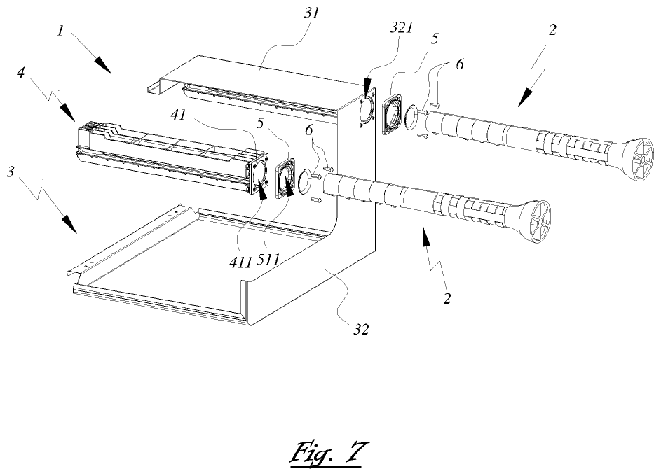

FIG. 7, an isometric view of the device applied to a metal box;

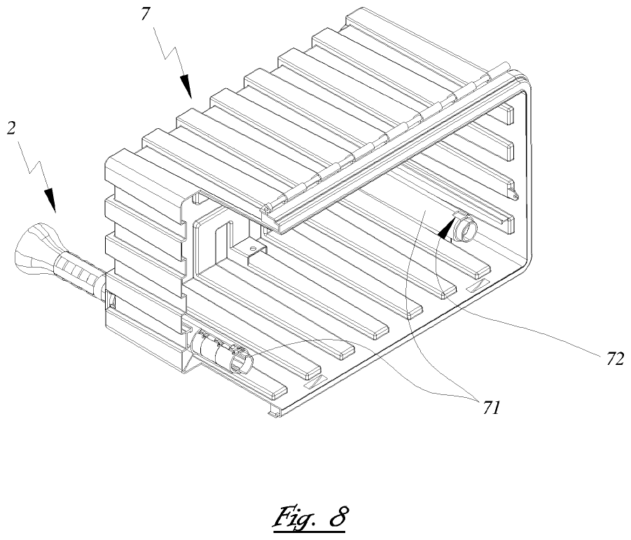

FIG. 8, an isometric view of the device applied to a box made of plastic material;

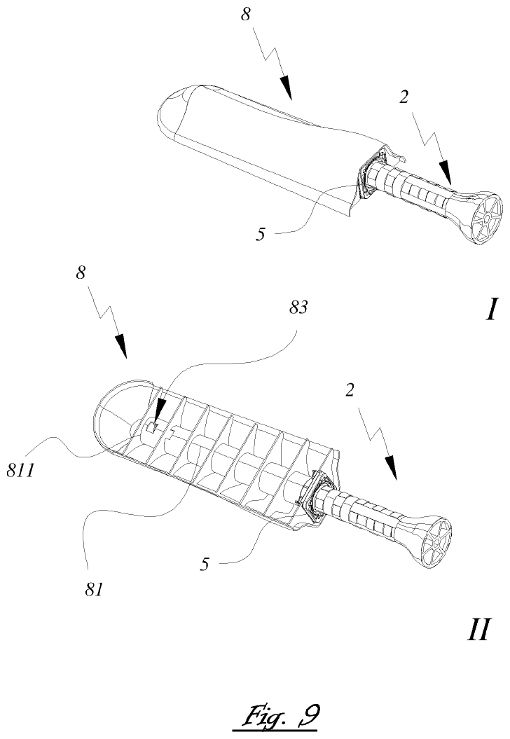

FIG. 9, an isometric view of the device applied to a fixing plate of a box;

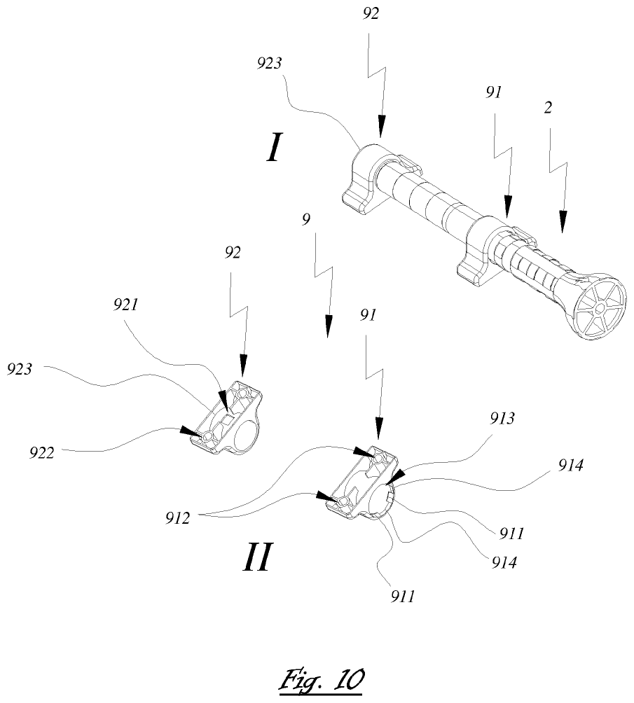

FIG. 10, an isometric view of the device applied to a pair of U-bolts;

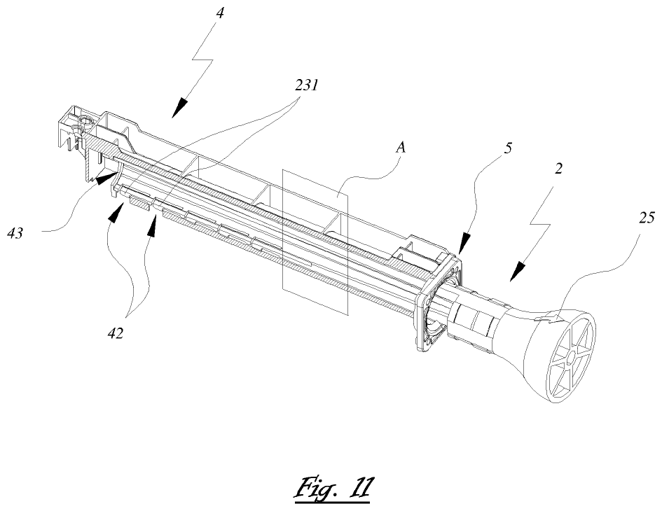

FIG. 11, an isometric and sectional view of the fastening condition of the tubular element inside a coupling element;

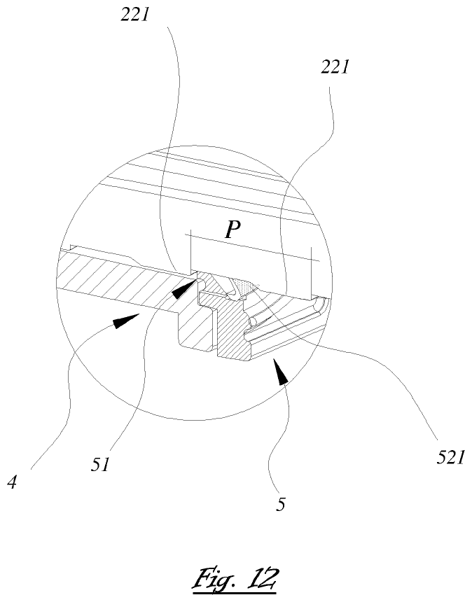

FIG. 12, a detail view of the fastening condition of the prismatic reliefs inside the toothed flange;

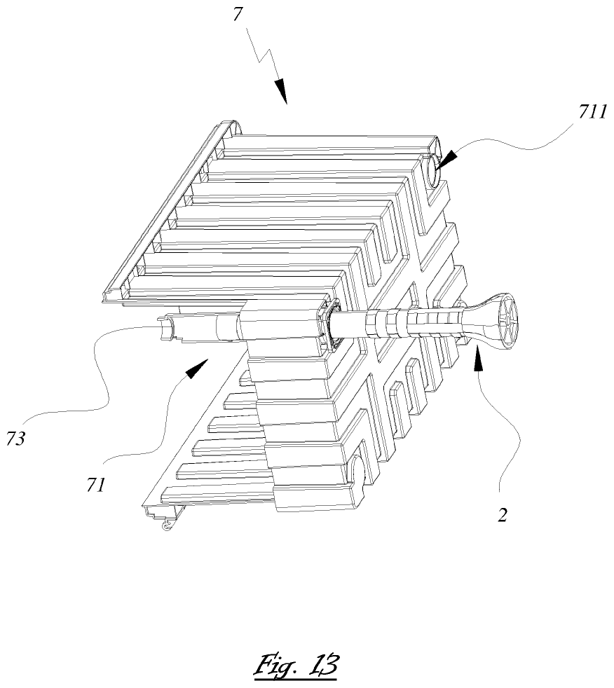

FIG. 13, an isometric and partial section view of the disinsertion manoeuvre of a tubular element inside a box made of plastic material;

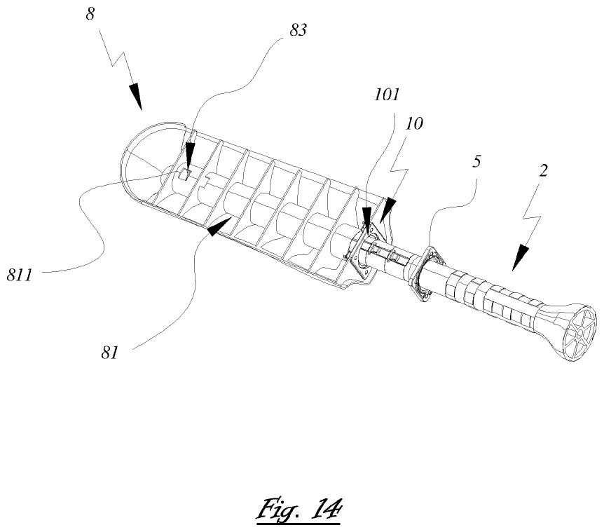

FIG. 14, an isometric, disinsertion manoeuvre view of a tubular element inside a plate;

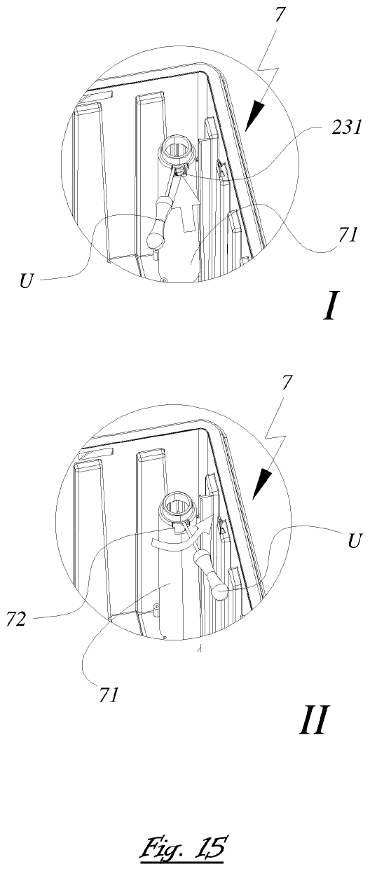

FIG. 15, the detail views of the removal manoeuvre of a plastic box fastened to a tubular element;

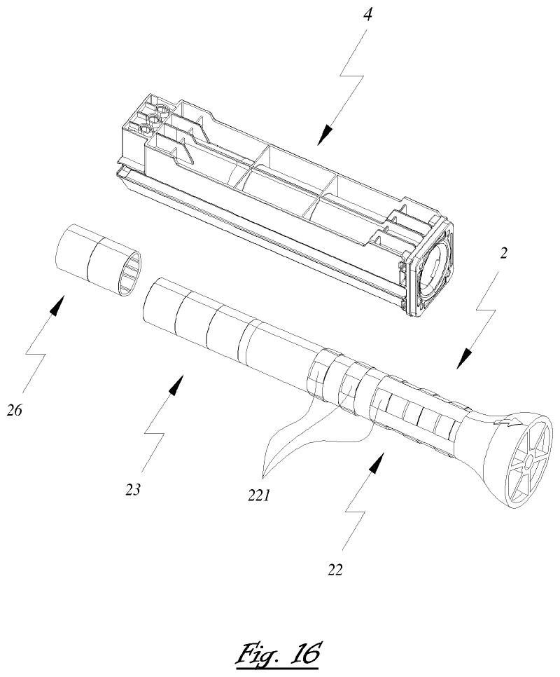

FIG. 16, an isometric view illustrating the reduction in length of a tubular element by removing a portion thereof, and the complementary thereof;

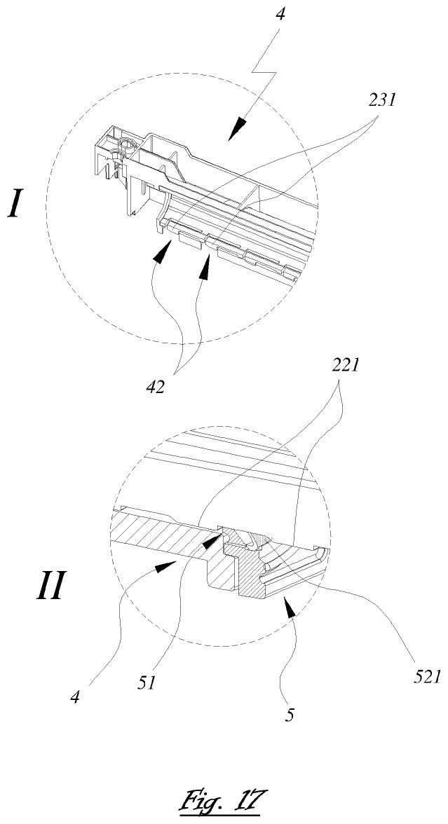

FIG. 17, the view of two details illustrating the fastening conditions of the toothed blocks with a coupling element and of the prismatic reliefs with the toothed flange.

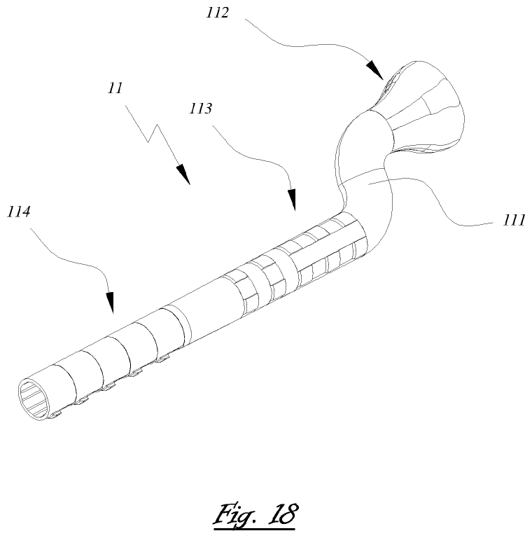

FIG. 18, an isometric view illustrating the tubular element provided with a gooseneck section.

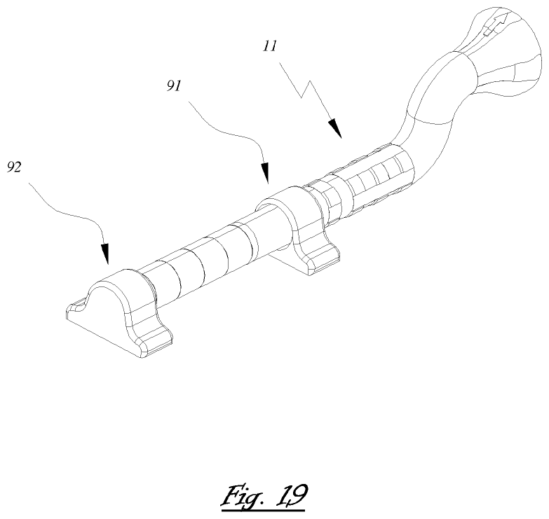

FIG. 19, an isometric view illustrating the tubular element provided with a gooseneck section applied to a pair of U-bolts.

As illustrated in FIG. 1, the device with adaptable elements, thereinafter referred to as device 1, suitable for fastening accessories boxes, license plate holders, light holders, fire extinguisher boxes, mudguards and so on to trucks, articulated lorries or heavy vehicles in general, consists of a tubular element 2 adapted to cooperate with both a coupling element 4 and a toothed flange 5, the latter being fastened on the front surface 41 of said coupling element 4.

The front surface 41 being equipped with a circular cavity 411 suitable for passing the tubular element 2 inside the coupling element 4.

As illustrated in FIG. 2, the tubular element 2 consists of a bell-shaped base 21, from which a first tubular section 22 extends, equipped with an annular sequence of prismatic reliefs 221, equidistant and circularly arranged, and of a second tubular section 23, equipped with a row of toothed blocks 231.

Said toothed blocks 231 are provided in equal number and equidistant with the same pitch P of the annular sequence of the prismatic reliefs 221 of the first tubular section 22.

The toothed blocks 231 geometrically protruding from the outer diameter of the second tubular section 23 are made so as to be capable of elastically recessing inside the tubular element 2, when pressed or countered by an external body.

As illustrated in FIG. 3, the tubular element 2 is provided with an internal cavity 24, originating at the first tubular section 22 and tapering to the end part of the second tubular section 23, said internal cavity 24 being further stiffened by a series of longitudinal ribs 241 radially arranged and suitable for assisting in the increase of the mechanical stiffness of the tubular element 2 against inflection and cut strains.

The bell-shaped base 21 of the tubular element 2 is stiffened by a sequence of ribs 211 radially arranged around a blind threaded hole 212, the latter being placed centrally to the bell-shaped base 21 to be suitable for fastening the tubular element 2 on a flat surface of a frame section by common fastening means.

As illustrated in detail in FIG. 4, at the protruding part of each toothed block 231, on the second tubular section 23, a pair of orifices 232 are made, suitable for engaging common tools U such as screwdrivers or pin punches or any instrument equipped with a shaft suitable for being constrained within them.

As illustrated in FIG. 5, the toothed flange 5 is internally equipped with a series of protruding teeth 51, circularly arranged, alternated by clearances 53 and provided by number and in accordance with a pitch such as to make them suitable for freely allowing consecutive passage of the toothed blocks 231 of the second section 23, during the disinsertion manoeuvre of a tubular element 2 inside a coupling element 4.

As illustrated again in FIG. 5, inside the toothed flange 5, a circular seat 52 is formed, adapted to house an annular lip element 521, made of elastomeric material and with a nearly conical geometry both to be suitable for elastically straining its internal diameter, during the transit of a tubular element 2 inside the toothed flange 5 itself and to be suitable for preventing water inlet inside the device 1.

In FIG. 6 the disinsertion condition of a tubular element 2 from the inside of the toothed flange 5, is illustrated, which may take place only after unscrewing from the vehicle frame, rotating the tubular element 2 of an angle such as to allow both the toothed blocks 231 of the second section 23 and the prismatic reliefs 221 of the first section 22 to freely flow inside the clearances 53 internal to the protruding teeth 51 of the toothed flange 5.

In case of application of the device 1 to a metal-type box 3, as illustrated in FIG. 7, there are two coupling elements 4 positioned at the internal ends of the upper metal sheet 31, of a metal box 3 and fastened, together with the respective toothed flanges 5, on an end metal sheet 32 by common reversible fastening means 6, at a pair of holes 321 made on said end metal sheet 32 and coincident with the circular cavities 411 of the coupling elements 4.

In the application of the device 1 to a plastic box 7, as illustrated in FIG. 8, the couplings 71 in which the tubular elements 2 will be constrained are directly formed in the mould of the plastic box 7.

In case of application of the device 1 to a plate 8, as illustrated in FIGS. 9 I and II, the tunnel 81 suitable for accommodating the tubular element 2 is formed in the mould of the plate 8 and said plate, the side the tubular element 2 is inserted in, is suitable for fastening the toothed flange 5.

As illustrated in FIGS. 10 I and II, using the device 1 to a fastening system consisting of U-bolts 9, said U-bolts being provided so that a first U-bolt 91 performs the same function as the toothed flange 5, that is to engage the prismatic reliefs 221 of the first section 22, by means of toothed elements 911 the first U-bolt is equipped with, while the second U-bolt 92 is equipped with a cavity 921 suitable for engaging a toothed block 231 of the second section 23 of the tubular element 2.

The preparatory step for the insertion manoeuvre of a tubular element 2 inside a coupling element 4 in case of metal box 3 or of a coupling 71 in case of plastic box 7 or of the tunnel 81 in case of plate 8 or inside U-bolts 91, 92 involves the preventive fixing of the tubular element 2 to the frame of vehicle by a common threaded connecting element with a predetermined tightening torque.

Fixing of the tubular element 2 to the frame shall be made with the reference 25 facing upwards, that is aligned with the longitudinal symmetry plane A of the coupling element 4, as illustrated in FIG. 11, and the tightening of said threaded connecting element shall not allow the rotation of the tubular element 2 around its axis.

Referring to FIG. 5, the insertion step of the tubular element 2 involves that the toothed blocks 231 freely pass through the clearances 53 present between the protruding teeth 51 of the flange 5, as the prismatic reliefs 221 make the protruding teeth 51 flex, engaging with said protruding teeth, providing a mechanism similar to that of a ratchet.

As illustrated in FIG. 11, the insertion manoeuvre of the tubular element 2 inside the coupling element 4 ends when the free front end of the tubular element 2 reaches the end wall 43 of the coupling element 4 and simultaneously the toothed blocks 231 engage inside the prismatic cavities 42 formed in the coupling element 4.

As illustrated in FIG. 12, in the previously described stroke end condition of the tubular element 2 inside the coupling element 4, the protruding teeth 51 of the toothed flange 5 have simultaneously engaged the respective prismatic reliefs 221 of the tubular element 2, so that the engagement of the tubular element 2 inside a coupling element 4 is subject to a double fastening condition in order to increase the safety thereof.

In order to apply the device 1 to a plastic box, as illustrated in FIGS. 8 and 13, the tubular element 2 is inserted in the couplings 71 directly formed in the plastic box 7, through the hole 511 and 711 of the toothed flange 5 and of the couplings 71, respectively.

The insertion step involves that the toothed blocks 231 freely pass through the clearances 53 between the protruding teeth 51 of the flange 5 and that the prismatic reliefs 221 make the protruding teeth 51 flex, engaging with said protruding teeth, providing a mechanism similar to that of a ratchet.

The stroke performed by the tubular element 2 by inserting it in the coupling 71, ends only when the free front end of the tubular element 2 comes into contact with the end wall 73. At the stroke end of the tubular element 2 inside the coupling 71, the toothed blocks 231 engage in appropriate seats 72 formed in the coupling 71 of the plastic box 7 and simultaneously the protruding teeth 51 of the flange 5, have already engaged the respective prismatic reliefs 221 of the first tubular section 22.

In the application of the device 1 with plate, as illustrated in FIGS. 9 and 14, the tubular element 2 is inserted inside the plate 8 passing through a hole 101 of a pierced plate 10, said plate being suitable both for being constrained on the plate 8 and for fastening the toothed flange 5.

The insertion step involves that the toothed blocks 231 freely pass through the clearances 53 between the protruding teeth 51 of the toothed flange 5 and simultaneously that the prismatic reliefs 221 make the protruding teeth 51 flex, engaging with said protruding teeth, providing a mechanism similar to that of a ratchet.

The stroke to the inlet of the tubular element 2 inside the plate 8 ends when its free front end 2 does not reach the end wall 811 of the tunnel 81 and, once reached such a position, the toothed blocks 231 of the second tubular section 23 engage in a seat 83 formed in the coupling element 81 of the plate 8. Simultaneously with the condition in which the tubular element 2 ended its stroke inside the tunnel 81 of the plate 8, the protruding teeth 51 of the flange 5 engaged the respective prismatic reliefs 221 of the first tubular section 22.

In the application of the device 1 to accessories which need a fixing by U-bolts, as illustrated in FIG. 10, the latter are fixed to the component or accessory to be fastened by common connecting elements, suitable for engaging in the seats 912 and 922, of which the first U-bolt 91 and the second U-bolt 92 are equipped with, respectively.

The first U-bolt 91 and the second U-bolt 92 shall be engaged to the accessory to be fastened so as to be mutually placed at a distance resulting an exact multiple of the pitch P of the toothed blocks 231, or of the prismatic reliefs 221.

Referring to FIG. 10 II, the tubular element 2 is inserted through the through hole 913 of the first U-bolt 91, so that the toothed blocks 231 freely pass through the clearances 914 interposed between the protruding teeth 911 of the first U-bolt 91, while the prismatic reliefs 221 of the first tubular section 22 assist in flexing the protruding teeth 911, engaging with said protruding teeth, providing a mechanism similar to that of a ratchet.

Fixing of the tubular element 2 is completed when the free front end of the tubular element 2 contacting with the end wall 923 of the second U-bolt 92 and simultaneously the toothed blocks 231 engage in the seat 921 prepared on the second U-bolt 92.

For the sake of simplicity of description, the method for removing the plastic box 7 from the tubular elements 2 to which it is fastened will be illustrated below, as the steps described below apply equally even in case of metal box 3 or in case of plate 8 or in case of U-bolts 91, 92.

The removal operation from a tubular element 2 is possible only after unfastening the latter from the vehicle frame, by a loosening action of the connecting mean engaged in the blind threaded hole 211 of the tubular element 2, to enable said tubular element to freely rotate.

As illustrated in FIGS. 15 I, II, in order to unfasten the coupling 71 of the plastic box 7 from the tubular element 2, it is necessary to exert pressure on the engaged toothed block 231, suitable for pushing the latter towards the interior of the tubular element 2, to be able to disengage it from the seat 72 and subsequently, by means of the engagement of a common U-tool such as a screwdriver or the like, inside the orifice 232 of the second tubular section 23, to force the tubular element 2 to rotate.

The rotation of the U-tool engaged inside the seat 72 of the coupling 71 shall allow the tubular element 2 to rotate of an angle α suitable for aligning the prismatic reliefs 221 thereof with the clearances 53 of the toothed flange 5 and subsequently, with the consequent removal of the U-tool from the orifices 232, the plastic box 7 can be extracted from the tubular element 2.

In order to be able to mount an accessory to be fastened with the device 1 at a lower distance from the vehicle or heavy vehicle, the tubular elements 2 will be reduced in length, as illustrated in FIG. 16 in case of metal box 3, depriving them at the ends of their second tubular section 23 of one or more tubular portions 26 comprising a finite amount of toothed blocks 231, so as to be able to engage the tubular elements 2 currently cut off, inside the same coupling elements 4, in a different configuration in length.

The procedure concerning the reduction in length of the tubular element 2 applied to a metal box 3, as described, applies even in case of plastic box 7, in case of plate 8 and for U-bolts 9.

As illustrated in FIGS. 17 I and II, adopting the same pitch P for the series of the toothed blocks 231 of the second tubular section 23 and the series of the prismatic reliefs 221 of the first tubular section 22 ensures even after removing the tubular portion 26 the correct engaging condition by the last toothed blocks 231 in the corresponding prismatic cavities 42 of the coupling element 4 and the simultaneous fastening condition of the corresponding prismatic relief 221 inside the toothed flange 5.

In order to allow accessories to be installed in an underlying position compared to the vehicle frame section where they are generally constrained, as illustrated in FIG. 18, the tubular element 11 may be provided by integrating it with a gooseneck section 111, adapted to connect the bell-shaped base 112 with the first tubular section 113, enabling to lower the quota of the first tubular section 113 and the second tubular section 114, compared to the quota of the bell-shaped base 112.

In FIG. 19, by way of example, the application of a tubular element 11 with a gooseneck 111, fastened to U-bolts 91, 92, is illustrated.

1. Device with adaptable elements, suitable for fastening boxes or components or other accessories to the frame of heavy vehicles, comprising a tubular element with a bell shaped base from which a first tubular section extends, and a second tubular section adapted to be constrained inside a coupling element, said coupling element being suitable for engaging, on a front surface, a toothed flange comprising an annular lip element inside, wherein the first tubular section of said tubular element is equipped with an annular sequence of equidistant prismatic reliefs circularly arranged, and the second tubular section of said tubular element is provided with a row of toothed blocks, of equal number and equidistant with the same pitch of the annular sequence of prismatic reliefs of the first tubular section.

2. Device with adaptable elements, suitable for fastening boxes or components or other accessories to the frame of heavy vehicles according to claim 1, wherein the removal of a tubular portion of the tubular element allows for installation of a metal box or a plastic box or a plate or U-bolts to the vehicle chassis, at a reduced distance by an amount exactly equal to the tubular portion removed.

3. Device with adaptable elements, suitable for fastening boxes or components or other accessories to the frame of heavy vehicles according to claim 1, wherein the toothed flange is internally equipped with a series of protruding teeth with an elastic behaviour suitable for allowing to be able to flex on the prismatic elements of the first tubular section to engage said prismatic elements after passing them.

4. Device with adaptable elements, suitable for fastening boxes or components or other accessories to the frame of heavy vehicles according to claim 3, wherein the protruding teeth of the toothed flange are geometrically made for being suitable for freely allowing, in their clearances, the transit of the toothed blocks of the second tubular section.

5. Device with adaptable elements, suitable for fastening boxes or components or other accessories to the frame of heavy vehicles according to claim 1, wherein, during disassembly, the tubular element can freely pass inside a toothed flange only if rotated of an angle a different from the alignment position between the longitudinal symmetry plane of the coupling element, with a reference placed on the bell shape of the tubular element.

6. Device with adaptable elements, suitable for fastening boxes or components or other accessories to the frame of heavy vehicles according to claim 1, wherein the coupling element, a coupling, the tunnel and the second U-bolt are equipped with at least one prismatic cavity suitable for engaging at least the last toothed block of the second tubular section.

7. Device with adaptable elements, suitable for fastening boxes or components or other accessories to the frame of heavy vehicles according to claim 5, wherein the tubular element is constrained inside the coupling element or the coupling or the tunnel or in the second U-bolt only when it comes into contact with an end surface and with the reference placed on the bell-shaped base, aligned with the longitudinal symmetry plane.

8. Device with adaptable elements, suitable for fastening boxes or components or other accessories to the frame of heavy vehicles according to claim 5, wherein the protruding teeth of the shaped flange, bind an annular section of prismatic reliefs of the first section of the tubular element, when said tubular element comes into contact with the end surface and with the reference placed on the bell-shaped base aligned with the longitudinal symmetry plane.

9. Device with adaptable elements, suitable for fastening boxes or components or other accessories to the frame of heavy vehicles according to claim 2, wherein the disengagement of the metal box or of the plastic box or the plate or of the U-bolt (9) from the tubular elements, takes place by applying sufficient pressure to make the engaged toothed blocks elastically retract inside the respective cavities and at the same time by means of a tool which, engaged in the orifices of the second tubular section, can rotate the tubular element by an angle a suitable for aligning the prismatic reliefs with the clearances of the toothed flange.

10. Device with adaptable elements, suitable for fastening boxes or components or other accessories to the frame of heavy vehicles according to claim 2, wherein the couplings, inside which the tubular elements are constrained, are directly formed in the mould of the plastic box.

11. Device with adaptable elements, suitable for fastening boxes or components or other accessories to the frame of heavy vehicles according to claim 2, wherein the tunnel, inside which the tubular element is constrained, is directly obtained in the mould of the plate, when said plate is made of plastic material.

12. Device with adaptable elements, suitable for fastening boxes or components or other accessories to the frame of heavy vehicles according to claim 2, wherein the U-bolts are pre-assembled on the accessory to fasten, at a distance among each other, corresponding to the exact multiple of the pitch of the toothed blocks, or of the prismatic reliefs.

13. Device with adaptable elements, suitable for fastening boxes or components or other accessories to the frame of heavy vehicles according to claim 1, wherein a tubular element is provided with a gooseneck section, adapted to connect the bell-shaped base with the first tubular section.

14. Device with adaptable elements, suitable for fastening boxes or components or other accessories to the frame of heavy vehicles according to claim 1, wherein in the condition in which the first tubular section of the tubular element is constrained inside the toothed flange, the internal diameter of the annular lip element engages the cylindrical surface which separates two annular sequences of consecutive prismatic reliefs.

15. Device with adaptable elements, suitable for fastening boxes or components or other accessories of heavy vehicles according to claim 1, wherein an internal cavity of the tubular element which starts at the first tubular section and tapers towards a terminal part of the second tubular section, is reinforced by a series of longitudinal ribs, neatly arranged.
